(19) United States
(12) Patent Application Publication
(10) Pub. No.: US 2026/0359235 A1
(43) Pub. Date: Nov. 12, 2026

(54) SYSTEMS AND METHODS ASSOCIATED WITH TAGGED PROGRAM COUNTER-BASED MEMORY ACCESS CONTROL SYSTEMS

(71) Applicant: Raptor IP Holdings, LLC, Poplar Grove, IL (US)

(72) Inventor: Timothy Raymond Pearson, Boone, IL (US)

(73) Assignee: Raptor IP Holdings, LLC, Poplar Grove, IL (US)

(21) Appl. No.: 19/648,775

(22) Filed: Apr. 15, 2026

Related U.S. Application Data
(60) Provisional application No. 63/804,057, filed on May 12, 2025.

(51) Int. Cl. G06F 12/14; G06F 12/0895

(52) U.S. Cl. CPC G06F 12/1441; G06F 12/0895; G06F 12/1458

(57) ABSTRACT

Hardware-enforced segmentation at the page level to leverage memory encryption to provide encryption-enforced page segmentation. The invention introduces a method where the tag value derived from the upper bits of the program counter determines whether memory access is allowed. A list of memory ranges and their access permissions (Read/Write/Execute) is maintained and enforced at runtime by hardware.

### BACKGROUND INFORMATION

### Field of the Disclosure

Examples of the present disclosure are related to systems and methods of hardware-enforced memory partitioning. More specifically, embodiments are directed towards tag values having one or more associated physical memory ranges.

### Background

Modern computing systems often support multiple privilege levels and security boundaries to ensure isolation between firmware, hypervisors, operating systems, and user-level applications. In multi-tenant environments such as cloud systems, memory isolation becomes especially critical to maintaining system integrity and protecting against compromise.

In computer memory management, a page refers to a fixed-size block of data within a larger memory space, similar to a page in a book, where each page holds data. Paging is a method of organizing memory into these pages, allowing for efficient memory allocations and swapping between main memory and secondary storage. Most conventional memory systems partition terabytes of data into 4K page chunks, resulting in many pages. Each page is allocated to a specific process, part of code, etc. However, because there are a large number of pages, the pages are susceptible to buffer overflow attacks where an attacker can potentially access the first page associated with a first process, and overrun a boundary and access a second page, which may allow the attacker to control the system

Accordingly, needs exists for systems and methods at a hardware level to enforce the segmentation of memory utilizing reserved bits (tag bits) of the physical program counter address, which are masked off when accessing memory , wherein the tag bits are configured to control allowed memory access at a hardware level. For example, the tag bits may control which memory encryption key is used for a specific range of pages, which may allow for different pages to be encrypted differently.

### SUMMARY

Examples of the present disclosure are related to systems and methods for hardware-enforced segmentation at the page level to leverage memory encryption to provide encryption-enforced page segmentation. The invention introduces a method where the tag value derived from reserved bits of the program counter, typically the upper bits, determines whether memory access is allowed. A list of memory ranges and their access permissions (Read/Write/Execute) is maintained and enforced at runtime by hardware. The disclosed embodiments provide a technical improvement to computer processor architecture by modifying instruction execution semantics such that a tag value derived from an instruction fetch address associated with a program counter is propagated through a processor pipeline and enforced by hardware at memory access points. Unlike software-enforced access control or pointer-based tagging systems, the disclosed embodiments enable hardware-level enforcement of memory isolation without requiring modification of application pointers or software instrumentation.

More specifically, embodiments are directed towards code that is executing from a specific location in memory and can either be accessed or denied access to any arbitrary page within the system at a hardware level. This allows authorized code to be allocated to a specific address in memory, which allows a program counter to include tag bits that identify the specific address in memory associated with the authorized code, wherein the tag bits are typically the upper portions of a wide physical program counter, which is typically 64 bits. To this end, the system may leverage otherwise unused (reserved) bits (tag bits), typically the upper bits, of the program counter, which are conventionally set to zeros or an arbitrary value, wherein the hardware masks off these reserved bits, but internally within the micro-architecture, these tag bits are retained. More specifically, embodiments may utilize upper bits of a program counter, and propagate such tag values, wherein access permissions are based on the executing code origin.

In other words, the program counter is prefixed with the tag bits, which are used as hardware enforced segment identifier, and because of this architecture when executing code from a location with a set tag bits to a value, the system can pull the tag bits and compare the tag bits to a page allocation table. Responsive to comparing the tag bits in the program counter to the tag bits in the page allocation table, the system may be able to determine if the chunk of code is authorized to access a page within memory. If the chunk of code is authorized to access the page, the page can be accessed; if not the access to the page may be denied.

In embodiments, the page table may be configured to allow for hardware-based lookups for access based on the tag bits of the program counter. Essentially, as program instructions are being passed around a CPU core, the 64-bit program counter automatically has its tag bits correspondingly passed around the CPU core. When load/store program instructions reach a point where the load/store program instructions are attempting to load, read, or write to RAM, then the hardware (such as a translation look aside buffer) may intercept the load/store program instructions and determine the tag bits associated with the program instructions. The hardware may determine if based on the tag bits, if the load/store program instructions pass to the cache unit or not. If not, the hardware may deny the program instructions or determine if an exception is met.

In embodiments, the processor core includes dedicated hardware structures configured to store, propagate, and evaluate tag values. The tag value associated with an instruction is maintained through many stages, and is provided to the memory access control logic. The memory access control logic performs a hardware comparison between the tag value and one or more entries in a tag range table before allowing a memory transaction to proceed to cache or memory. This enforcement occurs without software intervention during the execution of load and store instructions.

In some embodiments, enforcement of tag-based access control occurs prior to completion of a cache access and before issuance of a memory transaction on an interconnect, thereby reducing latency and preventing unauthorized data exposure within cache structures.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions, or rearrangements may be made within the scope of the invention, and the invention includes all such substitutions, modifications, additions, or rearrangements.

### BRIEF DESCRIPTION OF THE DRAWINGS

Non-limiting and non-exhaustive embodiments of the present invention are described concerning the following figures, wherein like reference numerals refer to like parts throughout the various views unless otherwise specified.

FIG. 1 depicts a topology for a system configured to utilize tag bits for program counters to control memory access via hardware, according to an embodiment.

FIG. 2 depicts a page lookup table, according to an embodiment.

FIG. 3 illustrates a method for system startup utilizing a page table, according to an embodiment.

FIG. 4 illustrates a method for firmware utilizing a page table, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present disclosure. Also, common but well-understood elements that are useful or necessary in a commercially feasible embodiment are often not depicted to facilitate a less obstructed view of these various embodiments of the present disclosure.

### DETAILED DESCRIPTION

In the following description, numerous specific details are outlined to provide a thorough understanding of the present embodiments. It will be apparent, however, to one having ordinary skill in the art that the specific detail need not be employed to practice the present embodiments. In other instances, well-known materials or methods have not been described in detail to avoid obscuring the present embodiments.

The mechanisms described herein are implemented at least in part in hardware and cannot be fully realized by software alone. In particular, propagation of tag bits through processor pipeline stages and enforcement at memory access points occurs within processor circuitry, and are not dependent on software-managed checks executed as program instructions.

Embodiments are directed towards systems and methods for controlling memory access using tagged upper bits of a 64-bit physical program counter address. The system utilizes upper bits that are typically masked off the upper 8 bits of the program counter, which serve as tag bits. These tags are used to restrict access to physical memory ranges based on hardware-level enforcement. Each tag corresponds to one or more memory regions defined in the tag range within a page lookup table. These registers are modifiable only by software executing at the predetermined privilege level. Memory access attempts from software executing under a given tag are permitted only if the requested memory falls within an allowable region associated with that tag. It should be evident to those skilled in the art that the methods described herein may be applied to protect data other than random access memory, for example memory mapped peripherals, memory mapped registers, nonvolatile memory (NVRAM), and related memory mapped devices.

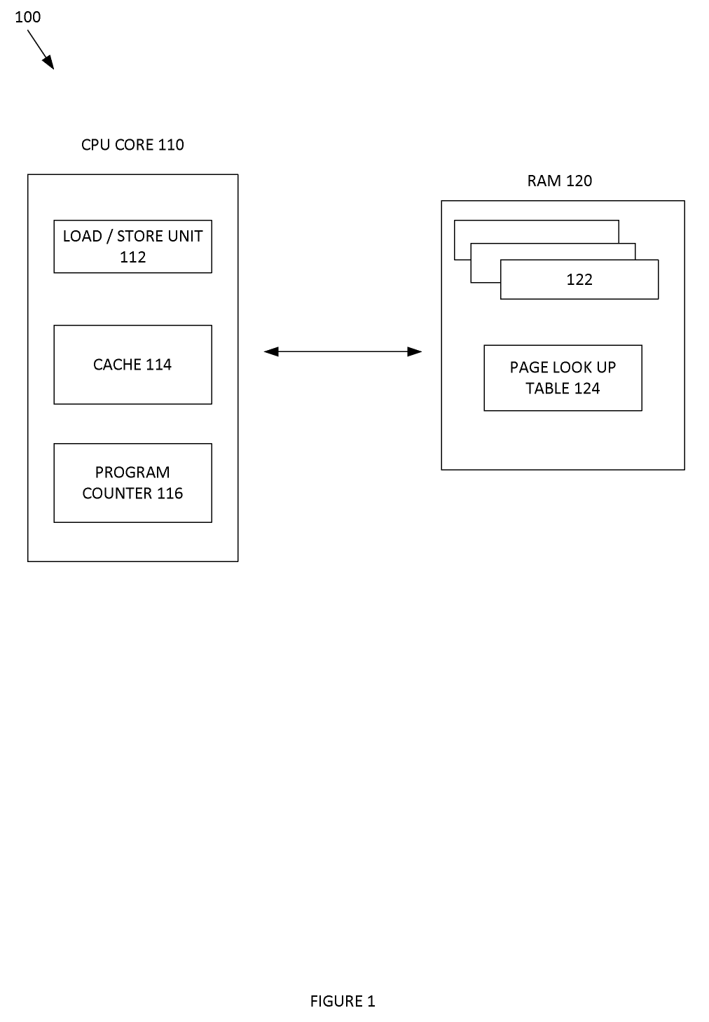

Turning now to FIG. 1, FIG. 1 depicts a topology for a system 100 configured to utilize tag bits for program counters to control memory access via hardware, according to an embodiment. System 100 may include a CPU core 110 and RAM 120.

A CPU core 110 may be a computer processing uniting a CPU that executes instructions and performs calculations. In embodiments, a computer may utilize a plurality of CPU cores 110 operating in parallel to each other. CPU core 110 may include load/store unit 112, cache 114, and program counter 116.

Load-store unit 112 may be a specialized executing unit responsible for executing all load and store instructions, generating virtual addresses of load and store operations, and loading data from memory or storing it back to memory from registers. Load-store unit 112 may include a queue that acts as a waiting area for instructions, and may operate independently of other processor units.

Cache 114 may be a memory unit built into the CPU core 110. Cache may be utilized to store frequently accessed data and instructions for quicker retrieval than accessing RAM 120. In embodiments, if program instructions are verified by page look-up table 124, they may pass from load-store unit 112 to cache 114.

Program counter 116 may be a special register within CPU core 110 that holds the memory address of the next instruction to be executed by load-store unit 112. After the CPU executes an instruction, the program counter 116 is updated to point to the next instruction in the sequence. This process is repeated for each instruction until the program completes. In embodiments, the instructions may be 64 bits, with the upper bits of the 64-bit address being tagged. In embodiments, the program counter includes a plurality of address bits and one or more tag bits encoded within a defined subset of bits, such as upper bits of the program counter. The lower bits may be address bits, which are portions of the are utilized to form a memory address for purposes of instruction fetch, data access, and address translation. The address bits correspond to a virtual or logical address that is translated, into a physical memory address. In contrast, one or more remaining bits of the program counter are designated as tag bits and are not used in forming the memory address. The tag bits are excluded from address translation and memory addressing operations but are retained within the processor microarchitecture and propagated with instruction metadata for use in hardware access control decisions. In this manner, the address bits determine a location in memory to be accessed, while the tag bits determine whether access to that location is permitted

The tagged bits may be configured to determine if the program instructions have access to pages 122 within RAM 120. Each tag may correspond to one or more memory regions defined in tag range control registers. Memory access attempts from software executing under a given tag are permitted only if the requested memory falls within an allowable region associated with that tag. In embodiments, every read and write operation generated by the CPU has an associated tag from the program counter's upper bits. This tag is propagated through all translation and cache levels until it reaches an encryption-capable (typically last-level) memory controller, at which point the associated encryption key stored in page lookup table 124 is used to encrypt or decrypt the data.

RAM 120 is a form of electronic computer memory that can be read and changed in any order. RAM 120 may include pages 122, which refers to a fixed-size block of data in virtual memory that is mapped to a corresponding physical memory frame. Paging is a memory management technique used by operating systems to efficiently allocate and utilize RAM 120, particularly in systems that use virtual memory. In embodiments, when program counter 116 needs to execute an instruction, the program counter 116 may find an address associated with the instructions, and the address is used to access the correct page 122 in RAM 120. More specifically, when the CPU needs to execute an instruction, the CPU first reads the address from the program counter 116, which may be the physical address in RAM 120. Once the physical address is determined, the CPU can access the memory location containing the instruction.

RAM 120 may include a page look-up table 124. A page table is a lookup table 124 used in computer memory management, particularly in virtual memory systems, to map virtual memory addresses to physical memory addresses. It essentially serves as a table that allows the system to translate virtual addresses used by processes to actual locations in RAM. In further embodiments, a protected TLB is used to cache the page lookup table 124 , and data access is allowed or blocked at the first-level cache based on the tag bits and contents of the page lookup table 124 . In embodiments, tag bits are latched into one or a register during a catch fetch. When a load or store instruction is issued associated with the tag bit, the associated tag bits are provided to a load/store unit. The load/store unit includes comparison circuitry configured to evaluate the tag bits against entries of the page look-up table 124. Based on a comparison of the tag bits and corresponding page look-up table 124, the load/store unit selectively permits or blocks forwarding of the memory request to cache or memory hierarchy components.

In further embodiments, the page lookup table 124 is stored in physical memory using a randomly generated encryption key, such that no element other than the initialized CPU can access or modify the page lookup table 124 in a deterministic manner.

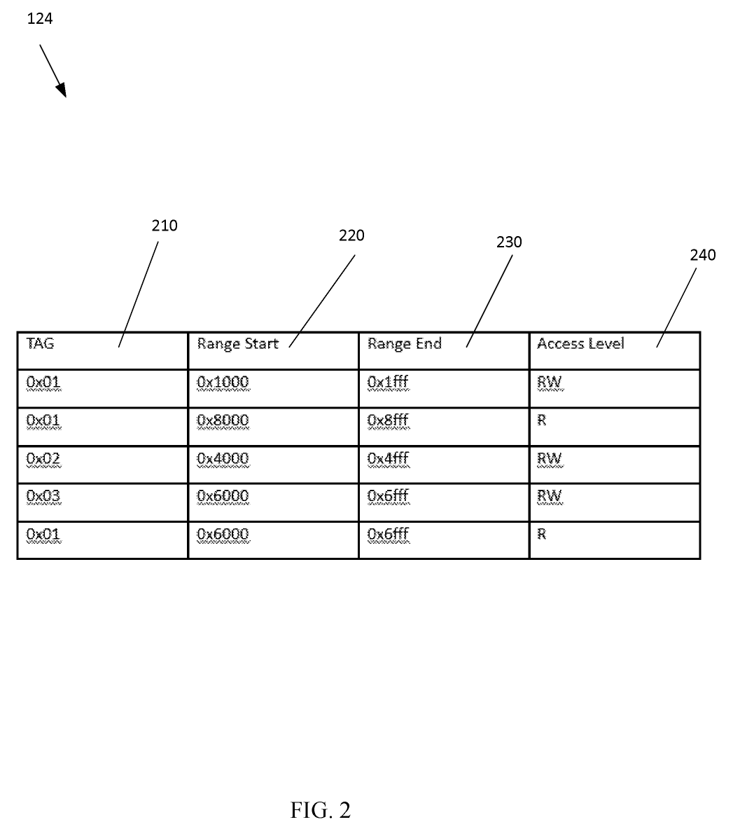

FIG. 2 depicts a page lookup table 124, according to an embodiment. Page look-up table 124 is a data structure used in virtual memory management. Page look-up table 124 maps a process's virtual address space to the physical memory space, enabling multiple processes to share the same physical memory while each has their own distinct virtual address space. In embodiments, a “tag” may refer to a portion of a memory address used in computer cache systems to uniquely identify which block of main memory is currently stored in a cache line. A “tag range table” refers to a hardware-accessible data structure that associates one or more tag values with corresponding memory address ranges and access permissions.

Page look-up table 124 may have a column associated with TAG bits 210, a column associated with a range start 220, a column associated with a range end 230, and a column associated with an access level.

In embodiments, a section of physical memory may be reserved for a Page lookup table 124. However, page look-up table 124 may not use memory ranges internally, but rather page identifiers in, e.g., a Radix system. This saves memory and speeds up translation, but is otherwise functionally equivalent (at page size granularity) to the memory range system shown for simplicity.

In implementation, every read and write operation generated by the CPU has an associated tag from the program counter's upper bits. If the program counter's physical addresses’ upper bits are set to 0x01, memory access operations will succeed for ranges associated with the first, second, and fifth row of the page look-up table 124 because these entries have corresponding tag values. However, if the program counter's physical addresses upper bits are set to are set to 0x01, memory access operations will be denied for ranges associated with the third and fourth page look-up table 124 because these entries do not have corresponding tag values (0x02 or 0x03). As such, memory read access operations will succeed in ranges 0x1000 to 0x1fff, 0x8000 to 0x8fff, and 0x6000 to 0x6fff. However, memory writes will be denied in ranges 0x6000 to 0x6fff and 0x8000 to 0x8fff. In other words, page look up table 124 may be set such that a range list includes the following: Tag 0x01 grants RW access to memory range 0x1000–0x1FFF and R access to 0x8000–0x8FFF, Tag 0x02 grants RW access to 0x4000–0x4FFF, Tag 0x03 grants RW access to 0x6000–0x6FFF, As such, overlapping access rules can coexist, e.g., Tag 0x01 also has R access to 0x6000–0x6FFF.

Page look-up table 124 may include special “executable” entries (not shown ), which define the tag used for pages that contain executable code. Unlike non-executable pages, executable pages may only have one tag set in the table. This may be implemented with a third bit, e.g., a three-bit ACL comprised of “X/R/W” bits.

This Page look up table 124 is only writable from the highest system privilege level, and contains authorized tags and access level for each page mapping. Optionally, it may also contain the memory encryption keys for that particular page.

The Page look up table’s 124 authorized tags, access level, and mappings may be readable from other privilege levels, but in all cases, the memory encryption keys will be masked (unavailable for read) from lower privilege levels. Any entry in the Page look-up table 124 may be marked as read-only by software running at the highest system privilege level. Read-only entries may then only be cleared by a full CPU reset, providing additional security from firmware compromise.

However, the program counter’s upper physical 8 bits will not be included in the memory access; i.e., if the program counter physical address was 0x0100000012345678, the memory access to retrieve the associated instruction will occur at physical location 0x0000000012345678.

Also in this example, if the program counter upper bits are 0x00, access will be denied for all memory regions listed in the table, and allowed for all other memory regions.

Also in this example, memory range [0x6000,0x6fff] is accessible by program code bearing either tag 0x01 or 0x03, with tag 0x01 having read-only access. When memory access is denied, the system may optionally raise a data exception and cause a trap for the operating system, hypervisor, ultravisor, or firmware handling. Furthermore, the special tag 0x00 indicates that no tag protection is present for those program counter values. Access to memory from unprotected (untagged) code may be denied for any memory range that is present in the tag range list. Conversely, code with any tag value can access any memory not listed in the tag range list.

In implementations, once a tag is set on a range in the page table, only system software executing with the same tag can modify the range information, including access level, or delete the range entirely. This may secure the range within the page table by not letting system software with different tags modify which locations of memory can be accessed.

When a tag is set in on a range in the page table, system software executing with that same tag may create new entries using the same range but with a different tag. This may enable system software to grant access to software running with another tag.

In further implementations, the memory subsystem will accept tagged memory addresses, from the core’s perspective, but those tag bits will be stripped out when translated to “real” (physically accessible) memory accesses at the last-level memory controller. This is needed to allow executable instruction load/store to operate, e.g., to load program counter and next instruction pointer registers, which often operate by simply loading the next instruction from “program counter plus one” or equivalents.

It should also be evident that the protections described above serve to prevent malicious code from attempting to synthesize and jump to a program counter with a tag value other than the system-authorized value. If such a program counter was synthesized and utilized, access would immediately be denied to the underlying page containing the malicious code due to the resulting tag bit mismatch, thus halting execution of the malicious code and, in embodiments, raising a hardware protection violation fault, for example to allow the operating system to take appropriate action.

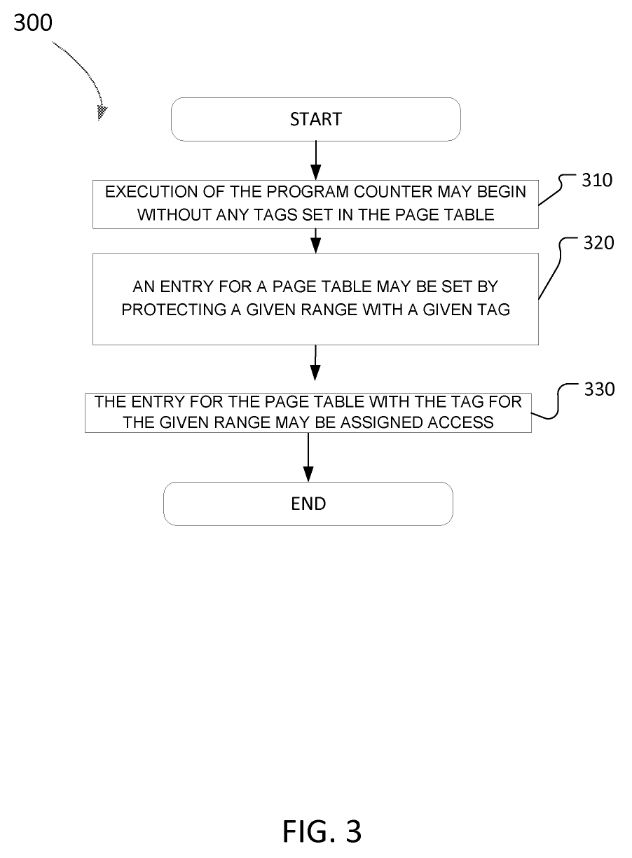

FIG. 3 illustrates a method 300 for system startup utilizing a page table, according to an embodiment. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a solid-state machine, reconfigurable logic, fixed logic, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for the execution of one or more of the operations of method 300.

At operation 310, execution of the program counter may begin without any tags set in the page table.

At operation 320, an entry for a page table may be set by protecting a given range with a given tag, wherein protecting a given range may be dedicating a range of tag bits for various security functions

At operation 330, the entry for the page table with the tag for the given range may be assigned read, write, or execute access.

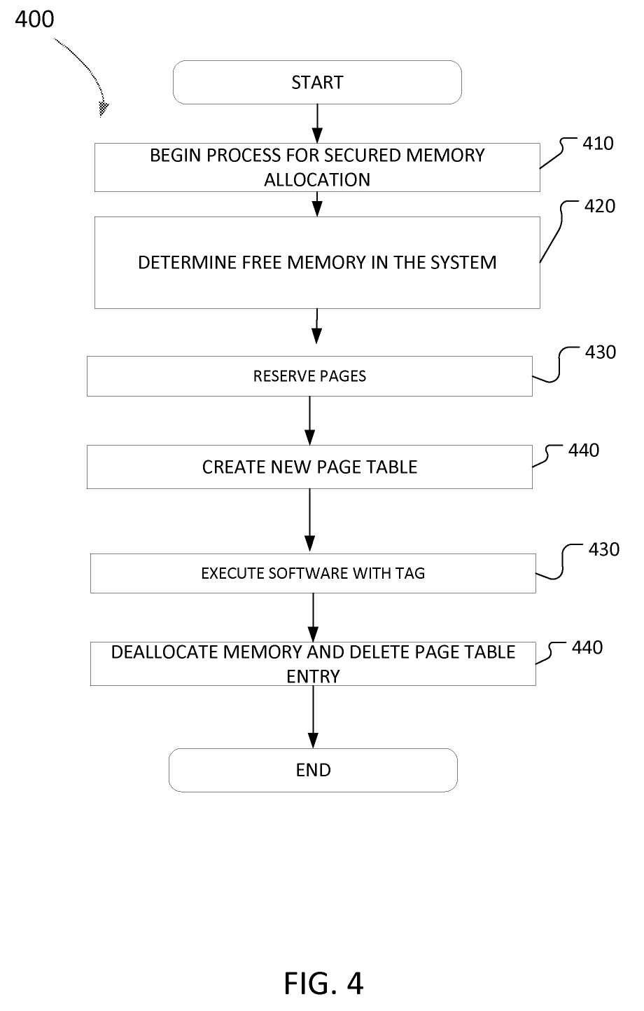

FIG. 4 illustrates a method 400 for firmware utilizing a page table, according to an embodiment. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below is not intended to be limiting.

In some embodiments, method 400 may be implemented in one or more processing devices (e.g., a digital processor, an analog processor, a digital circuit designed to process information, an analog circuit designed to process information, a solid-state machine, reconfigurable logic, fixed logic, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for the execution of one or more of the operations of method 400.

At operation 410, the normal process for secured memory allocation may begin.

At operation 420, free memory in the system may be determined.

At operation 430, pages associated with the free memory may be reserved.

At operation 440, a new page table entry may be created using a current tag, the entry may include access levels and memory range.

At operation 450, the system software executing with the same tag may be used, for example the new memory allocation may contain instructions which can subsequently be executed with hardware enforced memory isolation via the tag bits. Such execution cannot be modified by any other software within the system, and instructions within the new allocation cannot access memory set to different tag values, thus providing a means for configured system components (.e.g. firmware) to run without access to other system data.

At operation 460, after the software is executed, the entry and memory may be deallocated, and the page table entry may be deleted.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to "one embodiment", "an embodiment", "one example" or "an example" means that a particular feature, structure, or characteristic described in connection with the embodiment or example is included in at least one embodiment of the present invention. Thus, appearances of the phrases "in one embodiment", "in an embodiment", "one example" or "an example" in various places throughout this specification are not necessarily all referring to the same embodiment or example. Furthermore, the particular features, structures, or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable content may be utilized. For example, a computer-readable medium may include one or more of a portable computer diskette, a hard disk, a random access memory (RAM, DRAM, Flash, MRAM, etc.) device, a read-only memory (ROM) device, an erasable programmable read-only memory (EPROM or Flash memory) device, a portable compact disc read-only memory (CDROM), an optical storage device, and a magnetic storage device. Computer program code for carrying out the operations of the present invention may be written in any combination of one or more programming languages.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special-purpose hardware-based systems that perform the specified functions or acts, or combinations of special-purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

While specific bit widths have been provided for clarity in explaining the principle of operation, in practice bit widths other than 8 and 64 bits may be utilized, and in fact the number of reserved tag bits may be runtime configurable. Furthermore, program counter widths less than or greater than 64 bits may be used, e.g. to provide additional tag bits internally as required.

What is claimed is:

1. A system comprising
a computer processing core configured to execute instructions;
a program counter configured to store an instruction address, the instruction an address portion and a tag portion, the address portion being specific bits associated with address bits for a memory address, and the tag portion being reserved bits associated with tag bits that are utilized to determine access permission to the memory address;
a page lookup table including a plurality of entries, each entry include a tag value, address range, and at least one access permission;
a load store unit including hardware configured to receive the address portion associated with the instruction address, receive the tag portion and compare the tag portion with at least one tag value in the page lookup table, and selectively allow or deny the memory address based on a result of the comparison and the at least one access permission.

2. The system of claim 1, wherein the tag portion is ignored for address translation.

3. The system of claim 1, wherein the tag portion is propagated through multiple translation and cache levels.

4. The system of claim 1, wherein every instruction generated by the computer processing core includes an associated tag portion from the upper bits of the program counter.

5. The system of claim 4, wherein the program instructions are read or write operations.

6. The system of claim 5, wherein responsive to the tag value being set within the page lookup table only system software executing with corresponding tag portion can modify information associated with the address range.

7. The system of claim 5, wherein responsive to the tag value being set within the page lookup table only system software executing with the corresponding tag portion can modify information associated with the at least one access permission.

8. The system of claim 5, wherein responsive to the tag value being set for the address range, system software executing with the corresponding tag portion may create new entries using the address range but with a different tag value.

9. The system of claim 1, wherein the at least one access permission is a read access, write access, or execute address.

10. The system of claim 1, wherein after the instructions, the corresponding entry in the page table is deleted.
